(19) United States
(12) Patent Application Publication
(10) Pub. No.: US 2018/0210504 A1
(43) Pub. Date: Jul. 26, 2018

(54) LAPTOP COMPUTER WITH MULTIPLE INTEGRATED DISPLAYS

(71) Applicant: George MOSER, Santa Clara, CA (US)

(72) Inventor: George MOSER, Santa Clara, CA (US)

(21) Appl. No.: 15/651,581

(22) Filed: Jul. 17, 2017

Related U.S. Application Data
(60) Provisional application No. 62/604,031, filed on Jun. 21, 2017.
(60) Provisional application No. 62/603,475, filed on May 31, 2017.
(60) Provisional application No. 62/499,228, filed on Jan. 23, 2017.

(51) Int. Cl. G06F 1/16

(52) U.S. Cl. CPC G06F 1/1649; G06F 1/1681; G06F 1/1654; G06F 1/1679; G06F 1/1616

(57) ABSTRACT

A portable computer display unit interconnects with a base unit in a clamshell configuration. The display unit contains a first display panel. The base unit contains a second display panel. An angle adjustment mechanism may be provided to adjust the angle of the second display panel relative to a user's view, such as a hinge structure connecting a leading edge of the second display panel to the base unit. A second angle adjustment mechanism may operate to adjust the angle of the base unit relative to a surface on which the second angle adjustment mechanism rests. The display unit may further include a height adjustment mechanism. The height adjustment mechanism, first angle adjustment mechanism and second angle adjustment mechanism may be employed to optimize angles of view for both the first and second display screens, while preventing or minimizing visual occlusion of the first display panel by the second display panel.

### RELATED APPLICATION DATA

This application claims priority of: U.S. Provisional Patent Application No. 62/604,031 filed Jun. 21, 2017, U.S. Provisional Patent Application No. 62/603,475 filed May 31, 2017, and U.S. Provisional Patent Application No. 62/499,228 filed Jan. 23, 2017; the contents of each of which are hereby incorporated by reference.

### FIELD OF THE INVENTION

The present invention relates to the field of portable computers.

### BACKGROUND

Current laptop computers are very powerful but they are still limited in the effectiveness with which they can provide true multitasking capabilities to users. To multitask most efficiently, a user needs to see each task on a screen, and current laptops typically have only one screen. For example, it would be desirable to be able to see a document on one screen, and see a different document or read emails on another screen, and potentially transfer information from one screen to the other. That is currently not efficiently done on a conventional portable computer.

FIG. 1 shows a typical prior art laptop computer. This configuration includes base unit 10, which is pivotally connected to display unit 11 through hinges 15 and 16. The base unit 10 includes a keyboard 13 and a touchpad 14. The display unit 11 includes a display panel 12, typically an LCD screen.

Adding a second screen to a portable computer creates numerous challenges with regard to user experience, manufacturability, and reliability. Applicant's prior U.S. Pat. No. 9,501,097 B2, issued on Nov. 22, 2016, discloses several designs for effective implementation of a second screen on a portable computer. Further improvements are described herein.

### SUMMARY

A portable computer display unit interconnects with a base unit in a clamshell configuration. The display unit contains a first display panel. The base unit contains a second display panel. An angle adjustment mechanism may be provided to adjust the angle of the second display panel relative to a user's view, such as a hinge structure connecting a leading edge of the second display panel to the base unit. A second angle adjustment mechanism may operate to adjust the angle of the base unit relative to a surface on which the second angle adjustment mechanism rests. The display unit may further include a height adjustment mechanism. The height adjustment mechanism, first angle adjustment mechanism and second angle adjustment mechanism may be employed to optimize angles of view for both the first and second display screens, while preventing or minimizing visual occlusion of the first display panel by the second display panel. Numerous other embodiments having various features, variations and combinations are described herein.

### BRIEF DESCRIPTION OF THE DRAWINGS

FIG. 1 is a perspective view of a prior art portable computer.

FIG. 2 is a schematic diagram of a display screen viewing angle.

FIG. 3 is a schematic diagram of display screen viewing angles for a portable computer, in accordance with one embodiment.

FIG. 4 is a schematic diagram of display screen viewing angles for a portable computer, in accordance with another embodiment.

FIG. 5 is a front perspective view of a portable computer.

FIG. 6 is a side perspective view of a portable computer having a base unit incline mechanism.

FIG. 7 is a rear perspective view of the embodiment of FIG. 6.

FIG. 8 is a front perspective view of a portable computer having an adjustable secondary display screen.

FIG. 9 is a side perspective view of a portable computer having an adjustable secondary display screen and base unit incline mechanism.

FIG. 10 is a rear perspective view of the embodiment of FIG. 9.

FIG. 11 is a front perspective view of a portable computer having a relatively larger base unit display screen.

FIG. 12 is the embodiment of FIG. 11 with the secondary base unit display inclined at an alternative angle.

FIG. 13 is a perspective view of a portable computer having an adjustable height main display screen.

FIG. 14 is a partial cutaway view of a main display height adjustment mechanism.

FIG. 15 is a prior art keyboard arrangement.

FIG. 16 is a reduced-height keyboard arrangement.

FIG. 17 is a perspective view of another portable computer embodiment.

FIG. 18 is a rear perspective view of the embodiment of FIG. 17.

FIG. 19 is a side perspective view of a portable computer embodiment.

FIG. 20 is a rear perspective view of a portable computer embodiment with a base incline mechanism in a stowed position.

FIG. 21 is a perspective view of a portable computer embodiment having adjustable large second display screen and a base incline mechanism.

FIG. 22 is a rear perspective view of the embodiment of FIG. 21.

FIG. 23 is a schematic side view of a portable computer embodiment having multiple degrees of freedom for display adjustment.

FIG. 24 is a portable computer with an alternative base incline mechanism in a stowed position.

FIG. 25 is a portable computer with an alternative base incline mechanism in a deployed position.

FIG. 26 is a portable computer system with articulated base unit.

FIG. 27 is a portable computer with a base unit display overlay.

FIG. 28 is a perspective view of a base unit display overlay.

FIG. 29 is a portable computer with a base unit display overlay.

FIG. 30 is a portable computer with a base unit display overlay with deployed base incline mechanism.

FIG. 31 is a side perspective view of the embodiment of FIG. 30.

FIG. 32 is a front perspective view of a portable computer with primary and secondary displays and virtual keyboard.

FIG. 33 is a side perspective view of the embodiment of FIG. 32, with base incline mechanism deployed.

FIG. 34 is a perspective view of a portable computer with primary, secondary and keyboard display panels.

FIG. 35 is the portable computer of FIG. 34 with base unit overlay.

FIG. 36 is the portable computer of FIG. 35 with incline mechanism deployed.

FIG. 37 is a front perspective view of a portable computer system with primary and secondary displays and extended range hinges.

FIG. 38 is a rear perspective view of the portable computer of FIG. 37.

FIG. 39 is a perspective view of a portable computer with secondary display deployment mechanism.

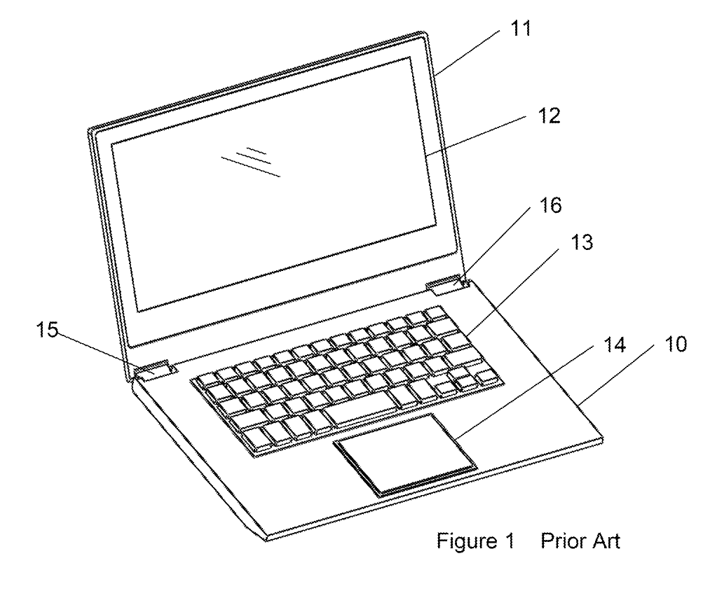

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention and is not intended to limit the invention to the embodiments illustrated.

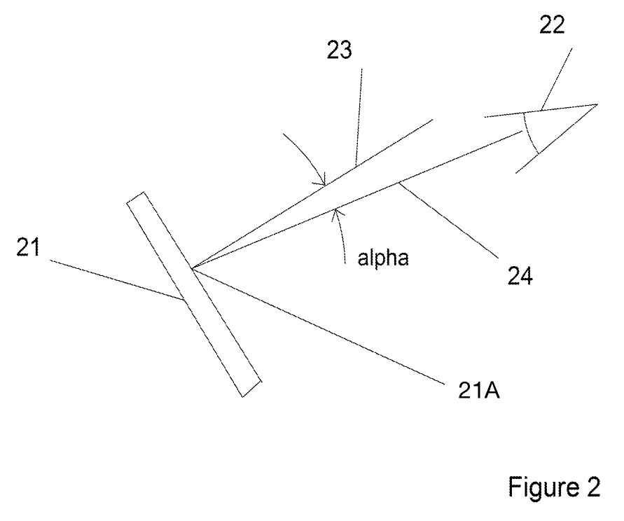

FIG. 2 is a schematic illustration of a user's view of a display screen. The user's eye 22 is focused on screen 21 through light beam 24. Line 23 is a line perpendicular to the surface of the screen, drawn at the point of incidence 21A of the light beam on the screen surface. The angle between that perpendicular line 23 and viewing line 24 is called the viewing angle alpha. Due to, e.g., characteristics of typical display screen technologies and surface reflectiveness, the viewing angle alpha typically has to be small for optimal image quality. As the viewing angle increases, the quality of the image seen by the user deteriorates. For the small viewing angle alpha as shown in FIG. 2, the image quality is still acceptable, but as that angle grows, the image quality degrades and ultimately becomes unacceptable.

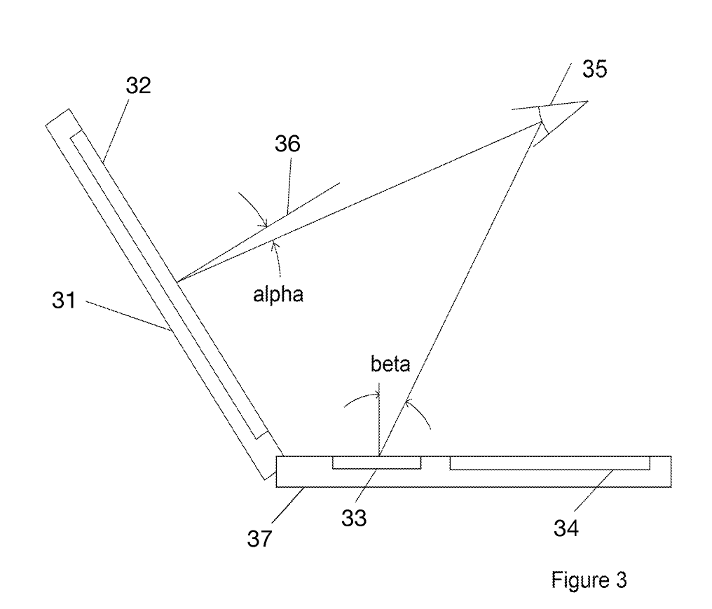

FIG. 3 is a schematic illustration of a laptop computer with a display unit 31 and base unit 37. Display unit 31 contains a primary screen 32. Base unit 37 includes a second display screen 33 and a keyboard 34. The user's eye 35 is looking at the primary screen 32 with a viewing angle alpha with respect to the perpendicular line 36. That viewing angle alpha is reasonable small, thus the image quality for the user is acceptable. Second display screen 33 is embedded in a fixed, non-adjustable position in base unit 37. The viewing angle beta for second display screen 33 is much wider than the viewing angle alpha, resulting in the user likely perceiving poor image quality on second display screen 33 if second display screen 33 is a standard electronic display panel. Several techniques are provided to improve performance of a base unit-mounted display screen.

One approach to improving a user's perception of a second display screen mounted within a laptop computer base unit is by using a second screen 33 especially designed for an extra wide viewing angle. A screen designed for a wide viewing angle allows the user to see the second screen 33 with acceptable image quality even if the surface of screen 33 remains essentially flat with respect to the user, as illustrated in the embodiment of FIG. 3. Numerous display manufacturers have developed manufacturing methods to optimize display screens for different viewing angles. Those techniques are well known to companies and persons skilled in the art of design and manufacture of displays, such as LCD displays commonly used in laptop computers. The approach shown in FIG. 3 therefore uses a second screen 33 which is embedded into the base 37 in a fixed, non-adjustable position. The surface of the second screen 33 remains always parallel to the surface of the base 37. This has the disadvantage that the user cannot adjust the viewing angle for maximum image quality, but it has the advantages of simplicity, ruggedness and low cost, which in certain cases may be critical.

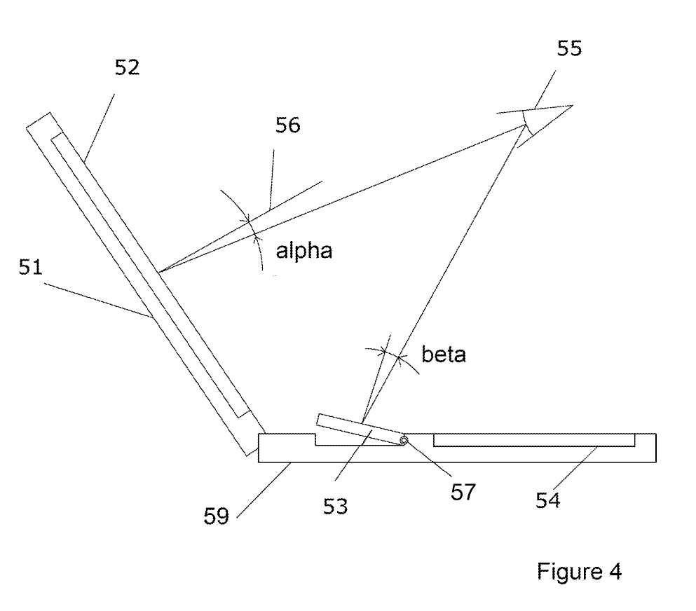

Another solution to improve a user's perception of a second display screen is by providing one or more mechanisms in the computer to allow the user to change and adjust the physical orientation of the second screen. One such embodiment is shown in FIG. 4. FIG. 4 is a schematic illustration of a laptop computer, shown in a cross-sectional side view. In FIG. 4, the second screen 53 has a mechanically adjustable angle, because it can rotate about hinge 57. Because of the rotation of the screen 53, the viewing angle beta in FIG. 4 becomes much smaller than the viewing angle beta in FIG. 3, improving the image quality perceived by the user when used with a conventional display panel 53. With this method, the second screen 53 can be designed and manufactured with a normal viewing angle (as opposed to a special screen with an extra wide viewing angle as described for FIG. 3). Therefore this embodiment provides potentially a lower cost second screen, since the requirements for the second screen are less stringent. Of course, it is also possible to use a second screen 53 with an extra wide viewing angle in an embodiment having an adjustable second screen angle, if so desired, in order to combine the benefits of a tilting angle about hinge 57 with the special wide angle screen design. In some embodiments, hinge 57 may be specified with two predetermined static positions, such that screen 53 may be toggled between a flat (closed) position and an open position at a predetermined angle relative to the plane of the top surface of base unit 59. In other embodiments, hinge 57 may include more than 2 predetermined static positions. In yet other embodiments, hinge 57 may enable the angle of second display screen 53 relative to base unit 59 to be continuously adjusted within a range. Many possible variations of this concept are possible.

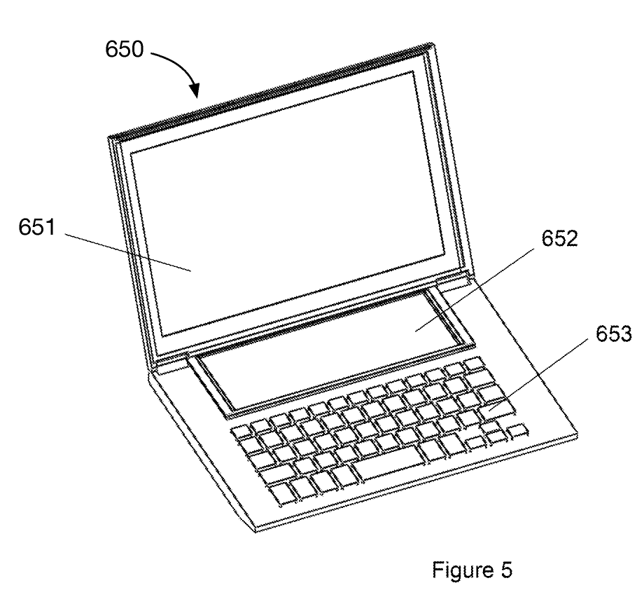

FIG. 5 is a perspective view of a fixed-position secondary display laptop computer comparable to that of FIG. 3. Computer 650 includes main display 651, a comparatively small second display 652 and a full size conventional keyboard 653. Optionally a touchpad can be added by slightly modifying the layout of second screen and keyboard. Inclusion of a touchpad may be perceived as optional in the embodiment of FIG. 5, because the second screen 652 can be a touchscreen, providing a means for user-specified selection and eliminating the need for a separate touchpad.

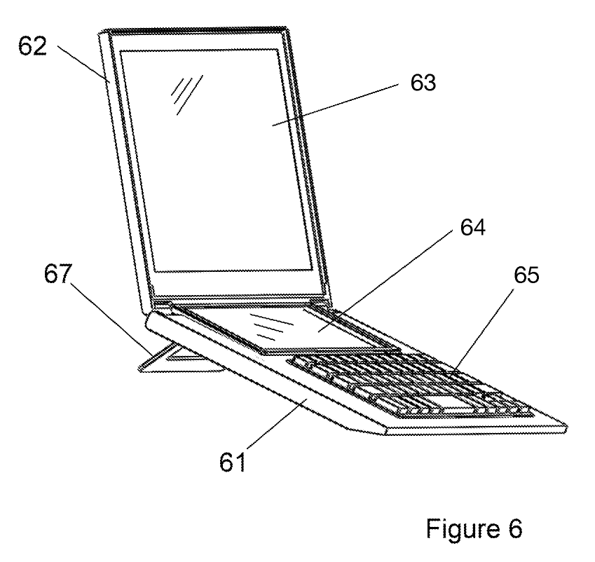

In some embodiments, users may adjust the viewing angle of a base unit-mounted second display screen, even when the second display screen is fixed within the laptop computer base unit, by adjusting the angle of the base unit within which the second display screen is mounted. FIG. 6 shows such an embodiment, in a side perspective view. This figure includes display unit 62 mounted to base unit 61 via adjustable hinges. Display unit 62 includes primary display screen 63. Base unit 61 includes second screen 64, keyboard 65 and incline mechanism 67. Incline mechanism 67 is illustrated in the embodiment of FIG. 6 as a deployable frame mounted on the underside of base unit 61. Incline mechanism 67 tilts the base 67 of the computer relative to a surface on which the computer rests, allowing the user to adjust the viewing angle of the second screen relative to themselves. While any adjustment of the incline mechanism 67 simultaneously causes a change in the viewing angle of the main screen 63, the viewing angle of main screen 63 may be easily adjusted by the user over a broad range, by manually pivoting display unit 62 relative to base unit 61 on its hinges.

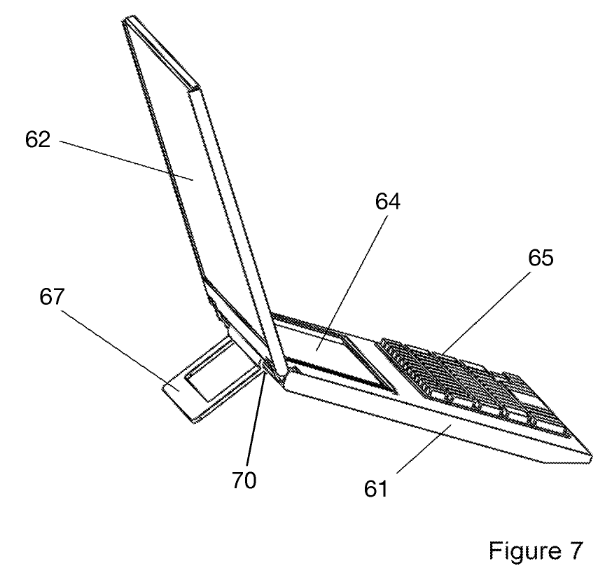

FIG. 7 is a rear perspective view of the same embodiment shown in FIG. 6. The incline mechanism 67 can be pivoted or hinged about the base unit 61 via hinge 70, mounted on base unit 61. In some embodiments, hinge 70 may be a mechanism that moves between two static positions (open or closed); in the closed position, mechanism 67 rests flush with the bottom side of base unit 61, while in the open position (shown in

FIG. 7), mechanism 67 extends downwards from the bottom side of base unit 61 to rest against a supporting surface and elevate the back portion of base unit 61 above the supporting surface. In other embodiments, hinge 70 may be adjustable between multiple static positions, or it may be continuously adjustable between a closed position and a range of open positions (e.g. by using a friction hinge for hinge 70).

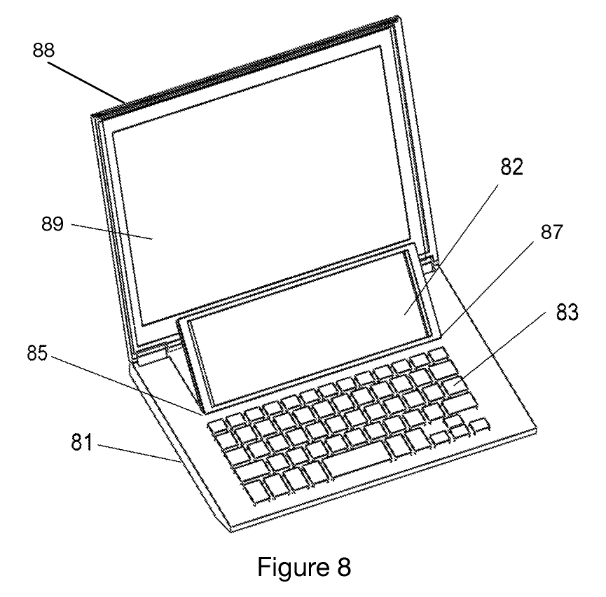

FIG. 8 shows another embodiment, wherein a relatively small, secondary screen 82 is mounted within a top surface of base unit 81, above or behind keyboard 83. A front or leading edge of secondary screen 82 is connected to base unit 81 via a left hinge or pivot mechanism 85 and a right hinge or pivot mechanism 87, such that secondary screen 82 can pivot upwards from the top surface of base 81 to a deployed position, as shown in FIG. 8. While illustrated in FIG. 8 as having two hinges 85 and 87, it is contemplated and understood that alternative mechanisms may be utilized to attach secondary screen 82 to base unit 81, including, without limitation, a single hinge structure extending across the entire front edge of secondary display screen 82. The laptop computer embodiment of FIG. 8 further includes primary display panel 89 within clamshell display unit 88. Display unit 88 may, amongst other things, fold down over the top of base unit 81 when secondary display screen 82 is stowed.

The embodiment of FIG. 8 does not have a base unit incline mechanism. Because the height of second screen is relatively small, visual interference between the second screen 82 and the main screen 85 is minimized (i.e. the second screen does not significantly block a user's view of primary display 88 during normal use). If the secondary base unit display screen is adjustable to a higher angle relative to base unit 81, or if the secondary display screen has a taller aspect ratio, visual occlusion of the primary display screen 89 could become an issue.

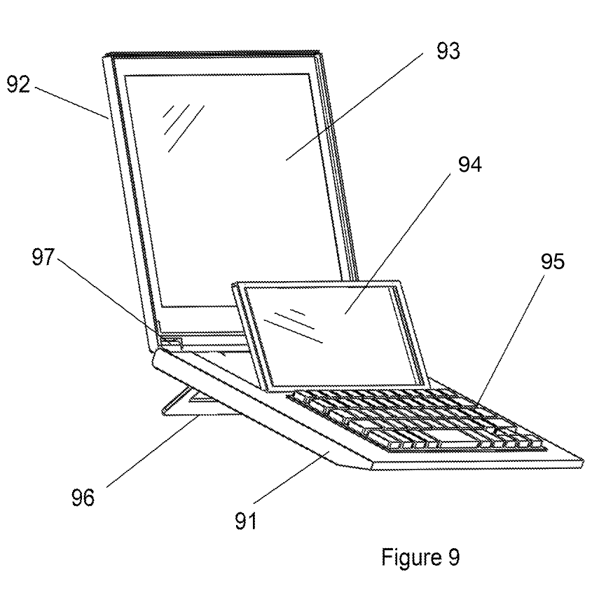

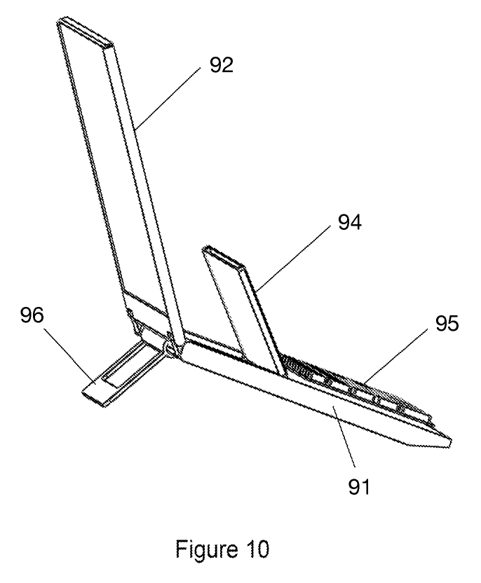

FIG. 9 shows a front perspective view of another embodiment combining an adjustable secondary, base unit display screen with a base unit support mechanism. FIG. 10 is a rear perspective view of the same dual adjustment mechanism embodiment of FIG. 9.

The laptop computer of FIG. 9 includes base unit 91 and display unit 92, arranged in a clamshell configuration. Display unit 92 includes primary display screen 93. Base unit 91 includes secondary display screen 94 mounted within a top surface of base unit 91, behind keyboard 95. Similarly to the embodiment of FIG. 8, secondary display screen 94 is mounted to base unit 91 via a hinge mechanism at the leading edge of display screen 94, such that a rear edge of display screen 94 may pivot upwards relative to the top surface of base unit 91. Base unit 91 also includes an incline mechanism 96, analogous to the incline mechanism provided in the embodiment of

FIGS. 6 and 7, permitting adjustment of the angle at which base unit 91 rests on a supporting surface. This embodiment includes both adjustability of the second screen 94 and also adjustability of the base through its incline mechanism 96. The combination of an angle adjustment mechanism for second screen 94, with base unit incline mechanism 96, may be very advantageous, because, e.g., the two adjustments are additive to control a viewer's angle of incidence for secondary display screen 94, as well as the extent to which secondary screen 94 may block a user's view of primary screen 93, permitting optimal viewing conditions with only moderate adjustments of each degree of freedom. If the only adjustment provided was the rotation of the second screen 94, some users may need a high angle of the second screen that could cause blocking of the main screen. That can be easily avoided in this embodiment by not turning up the second display too much, and instead relying partly on the incline mechanism 96 to achieve the desired viewing angle. Conversely, if the only adjustment provided was the incline mechanism 96, the user may need to use a very high incline to achieve a desired viewing angle, which could make the computer feel unstable, too high or hard to use the keyboard. The combination of the two mechanisms enables optimum configurability.

The hinges connecting the main display to the base (such as hinge 97 in FIG. 9) are preferably hinges with very wide angular range, such as Yoga type hinges (also known as multimodal hinges or hinges for 2-in-one laptops). The wide angular range facilitates the dual adjustment method described above, because when the base is tilted up by the incline mechanism 96 to set the viewing angle for the second screen, the main screen typically needs to be turned rearward away from the user to reset the viewing angle for the main display. Having an extended range hinges (such as 97) facilitates that.

Embodiments may preferably employ hinges with very wide range to achieve, inter alia, one or more of three objectives: (1) to make it easier for the user to find the optimum viewing angle; (2) to facilitate using the computer for presentations, with the user/presenter on one side and the audience on the opposite side of the computer folded in the shape of a triangle with the extended range hinges on the top of that triangle; and (3) to facilitate using the computer of this invention as a tablet, by folding it in the just described triangular arrangement, or even completely around to a flat configuration in which the back side of the display unit rests flush against the back side of the base unit. In some embodiments, wide range hinges may enable adjust of the display unit relative to the base unit over a range of significantly greater than 180 degrees, such as approximately 360 degrees.

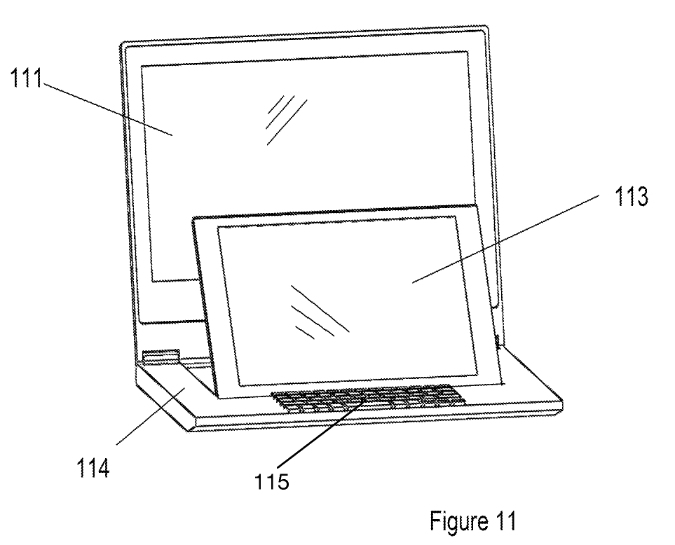

FIG. 11 shows another embodiment of the invention with a main display 111, a larger second display 113 and a reduced size keyboard 115. The large second display 113 occupies the majority of the space of the available space in the computer base 114, and therefore the keyboard 115 is preferably made of a reduced size. The size reduction of the keyboard in this invention can be achieved by two methods (or a combination thereof):

a) by reducing the size of the keys and/or reducing the pitch (distance between keys) by arranging the keys closer to each other. This approach is very viable and appropriate for some users, but it may be inconvenient to some users who are used to a full size keyboard, or

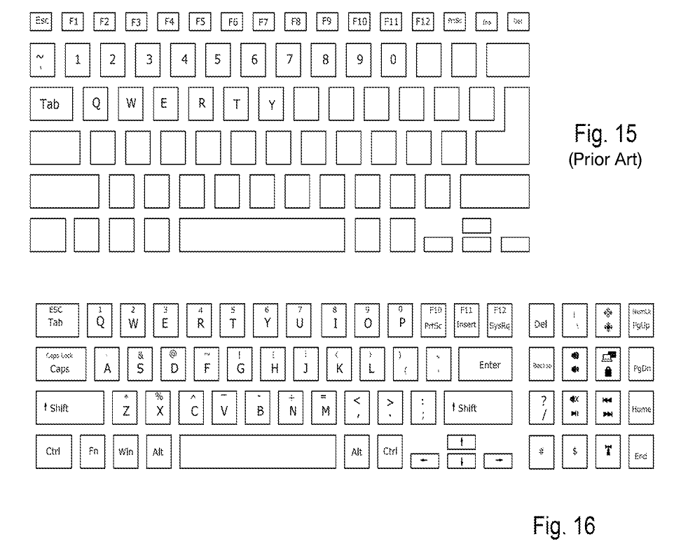

b) by reducing the number of rows in the keyboard by making multiple assignments to each key (illustrated further below in connection with FIG. 15 and FIG. 16).

The large second display 113 is generally more convenient or provides for functionality to the user than a small display, enabling more efficient multitasking and creating convenience and productivity advantages. At the same time though, such a large second display 113 has the potential disadvantage that when it is deployed, it can partially block the view of the main display, as shown in FIG. 11.

Specifically, FIG. 11 illustrates a front perspective view similar to that which may be observed by a user, with an upper portion of the second display 113 partially blocking the lower portion of the main screen 111. However, in some embodiments, this issue may be mitigated or avoided by different methods (or a combination thereof), including:

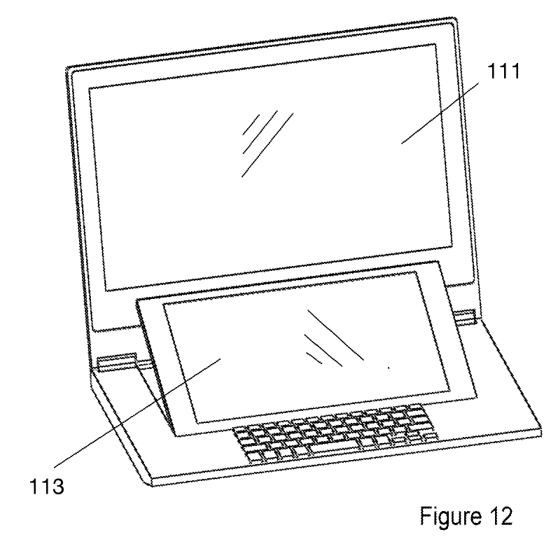

a) by designing the screen 113 with a wide viewing angle, which allows the user to deploy screen 113 at a lower angle that does not significantly block the view of the main screen 111, while still providing good image quality for second display 113, as shown in the configuration of FIG. 12, or

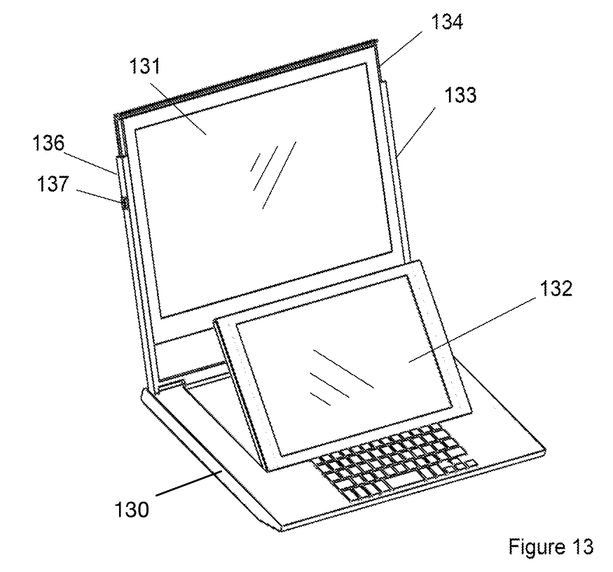

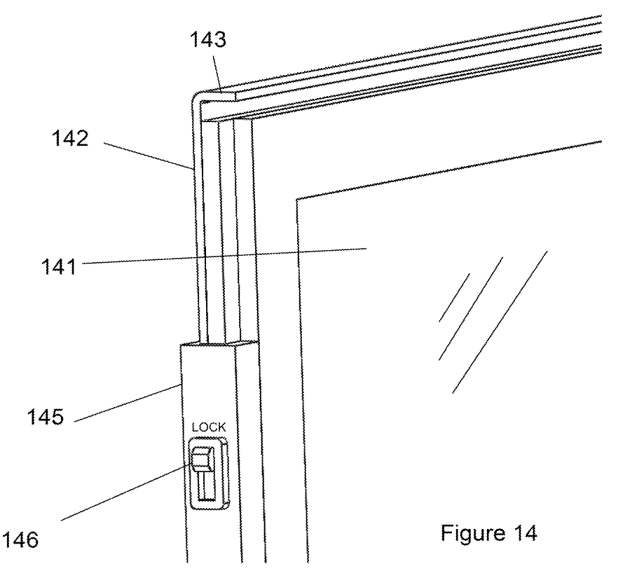

b) by providing a lift mechanism in the main display unit that allows the user to raise the main screen to a higher position that prevents or minimizes the view blockage, as shown in FIG. 13 and FIG. 14, or

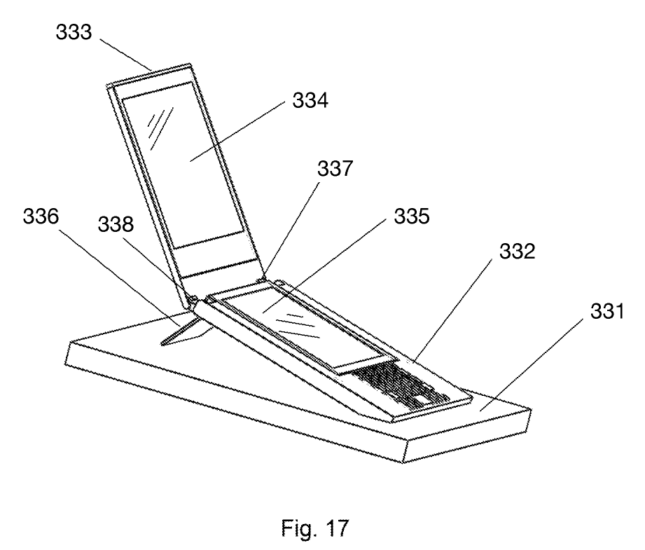

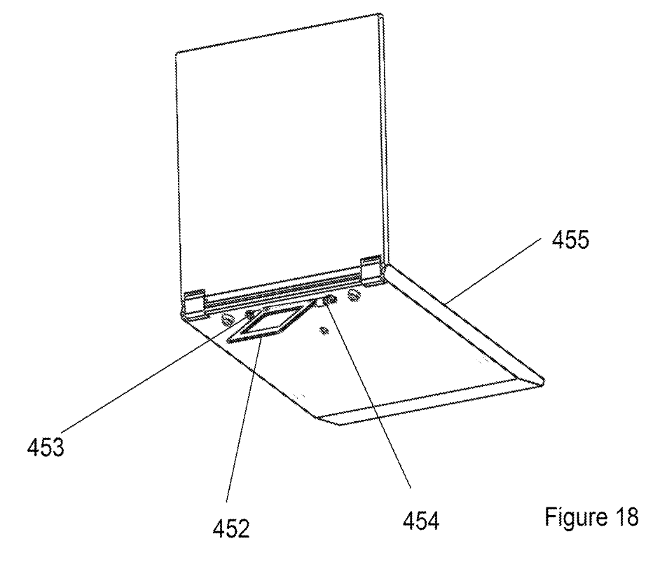

c) by providing an incline mechanism that raises the laptop base to an angle, as shown in FIG. 17.

For example, FIG. 12 shows an embodiment utilizing with a base unit LCD screen designed with an extra wide viewing angle that provides acceptable image quality for second display 113 even when the second display 113 is raised only by a small angle to minimize interference with the main display 111.

FIG. 13 shows an embodiment with a relatively large second screen 132 in the base unit 130, illustrated as being deployed at a relatively high angle by the user for his/her convenience and optimal viewing of second screen 132. A display unit is mounted to base unit 130 in a clamshell configuration, and includes primary display screen 131, mounted on a slidable carrier structure 134, which the user can slide up or down relative to display unit rails 133 and 136. Rails 133 and 136 are hingedly mounted to base unit 130 using hinges such as those described in connection with other embodiments.

In operation, the user can adjust the angles of view for both primary screen 131 and second screen 132 to desired angles of view that maximize image quality on each screen, while adjusting the height of main screen 131 above base unit 130 to prevent or minimize visual occlusion of main screen 131 by second screen 132. To hold the main screen 131 at the desired elevation, a brake or detent mechanism 137 may be included within one or more of rails 136 and 133. Brake or detent mechanism 137 can be moved by the user to a locked or unlocked position, to either release or lock the position of main screen 131 relative to rails 133 and 136.

FIG. 14 shows further details of an embodiment having a brake or detent mechanism for a slidable main screen 141. The slidable carrier plate 142 carries the screen 141, and allows adjustment of the position of screen 141 by sliding along rail 145. The brake mechanism to hold the screen 141 in a desired position by the user has a button or slide 146 that can be moved to a LOCK position to stop the screen 141 at the desired height. The brake can be designed and built in many different forms and embodiments. One possible embodiment is a small angular ramp that gets depressed by the button to cause a frictional engagement between the rail 145 and the carrier 142 when the button is moved to the LOCK position. Another possible embodiment of the brake mechanism can be a positive engagement mechanism, where the button is pushed in to engage with a hole or other shape in the rail. Another possible embodiment is a magnetic brake, where the button 146 moves a small magnet from a more distant position to a closer position to the rail, magnetically coupling them. There are many different possible ways and embodiments to arrest a slide inside a rail.

FIG. 15 shows a conventional keyboard for comparison purposes, and FIG. 16 shows a keyboard with reduced height in vertical direction and increased length in horizontal direction. The reduced height is achieved in this embodiment by assigning multiple functions to all or most of the keys. The reduced height keyboard facilitates the previously described embodiments with a large second screen, by reducing the surface area of the laptop base unit consumed by the keyboard.

FIG. 17 shows a computer embodiment having a secondary base unit display screen and base unit support mechanism, sitting on a desktop surface 331. The laptop includes a display unit 333 with a main screen 334, and a laptop base 332 with a secondary large screen 335. Base unit 332 also includes an incline mechanism 336 that the user can deploy to change and adjust the angle of the base unit 332, and therefore also second screen 335, with respect to the desktop surface 331, thus providing a favorable viewing angle for the second screen 335. The angle of the main screen 334 can also be adjusted by the user by pivoting the main display unit 333 about the computer hinges 337 and 338 as needed at any time. The hinges 337 and 338 are preferably of the extended extra wide range type, to make it possible to conveniently adjust the main screen 334 even for high levels of incline that can be achieved with the incline mechanism 336. This solution provides a favorable viewing angle for the user, making it possible for the laptop manufacturer to use a standard LCD display for the second screen without special optical designs to mitigate an unfavorable viewing angle. This keeps the cost down and provides good image quality for both screens.

FIG. 18 shows a lower rear perspective view of an embodiment have a base unit incline mechanism, such as that of FIG. 6, where the incline support mechanism is an a deployed position. The laptop base 455 is inclined at an angle due to the deployed incline mechanism, which includes the support frame 452 and the two friction hinges 453 and 454 that hold the support frame rotatably in position. The user can adjust support frame 452 continuously to any desired angle within the range of the hinges 453 and 454. Many variations are possible. The incline mechanism can be designed in many different ways.

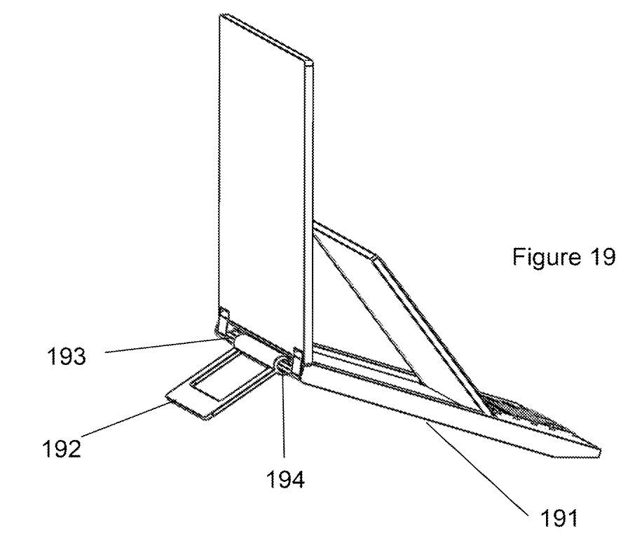

FIG. 19 shows a different approach, which consists of a rotatable tab 192 that is pivoted near the rear of the computer base 191. The tab can freely rotate about its pivots 193 and 194 up to a maximum angle defined by a mechanical stop. When not in use, the tab can be normally folded against the bottom of the base, held up by a magnet or by a latch mechanism or by friction or other means.

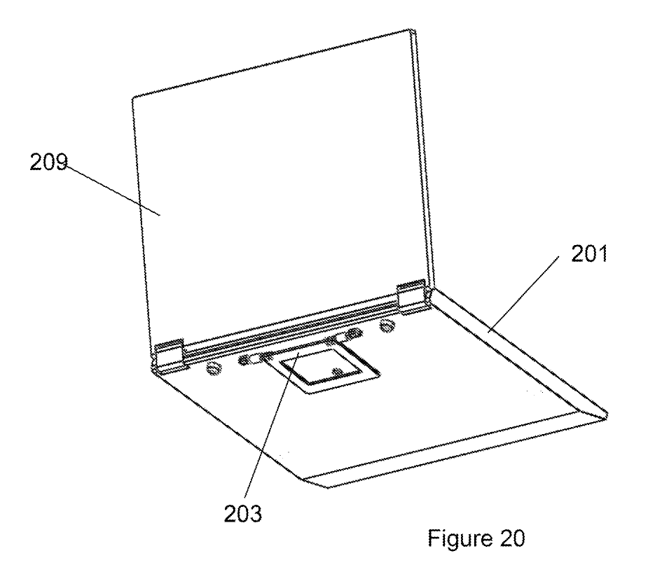

FIG. 20 shows the bottom of a laptop base 201, to which incline mechanism 203 is mounted and positioned in non-deployed position, closed against the bottom of base unit 201 and flush with its bottom surface. This allows the user to use the laptop in non-inclined position with a single screen only for, e.g., simple tasks that don't require multitasking use of a second screen. The incline mechanism can then be deployed when needed for multitasking tasks that would require the second screen, thus providing maximum flexibility to the user.

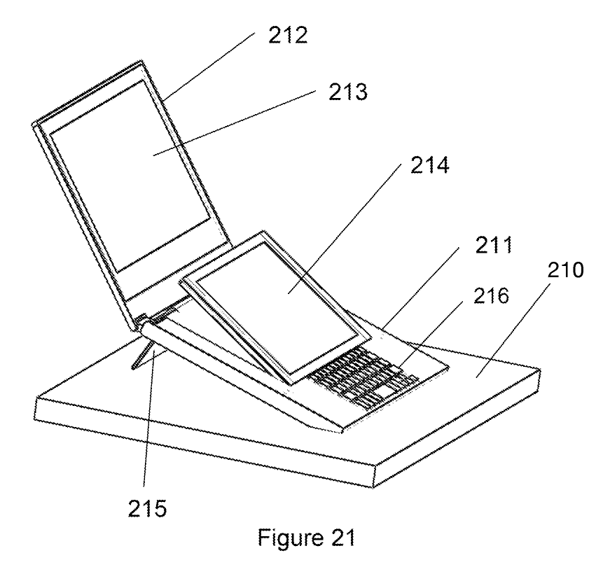

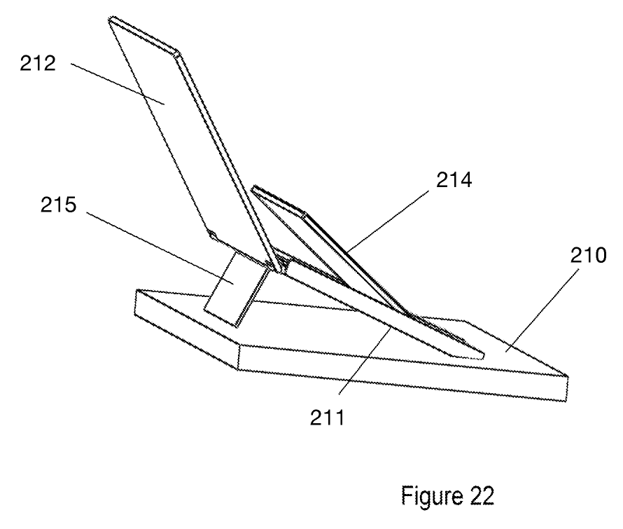

FIG. 21 shows another embodiment analogous to that of FIG. 10, with base unit incline and base display screen angle adjustability, but having a larger second screen. The laptop is sitting on desktop surface 210, and it includes a display unit 212 with a main screen 213, and a base 211 with a large second screen 214 and an incline mechanism 215. In this embodiment, the second screen 214 is hinged about the base 211 at the leading edge of display 214, allowing the user to vary the angle between the secondary screen 214 and the base 211, in order to adjust the viewing angle. Therefore, the user is provided with dual adjustability: both the second screen and the angle of the base are adjustable. This makes it possible to avoid the blocking of the main screen 213 by the second screen 214. This embodiment can also be combined with the liftable main screen previously shown in FIG. 13, providing triple adjustability. FIG. 22 shows the rear of the embodiment of FIG. 21.

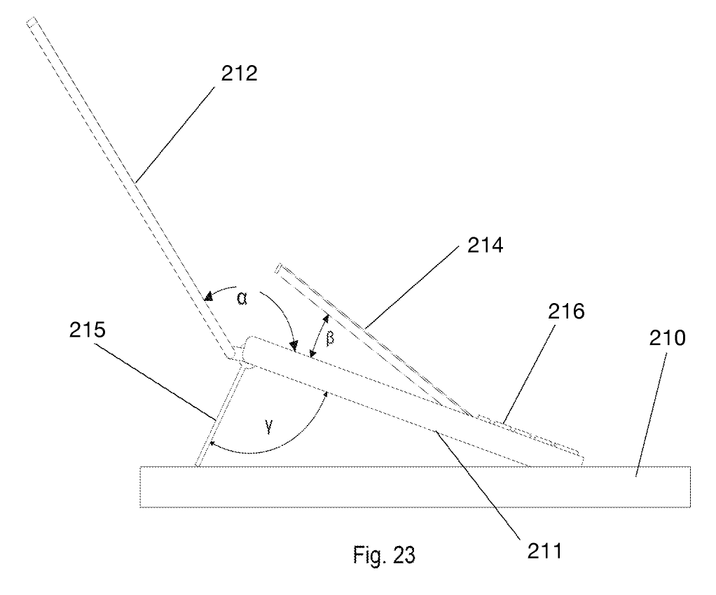

FIG. 23 illustrates the multiple degrees of freedom for display orientation provided to a user by the embodiment of FIGS. 21 and 22. The secondary screen 214 has an adjustable angle β between the secondary screen 214 and the base 211. The laptop base 211 has an adjustable angle γ between the laptop base 211 and the desktop surface 210 (or the user's lap surface if so preferred by the user) . The main display 212 has an adjustable angle α between the laptop base 211 and the main display 212. The user can easily adjust all those degrees of freedom as desired at any time, providing unprecedented productivity and convenience in a highly efficient multitasking portable environment. Blocking of the main screen 212 by the second screen 214 can be avoided.

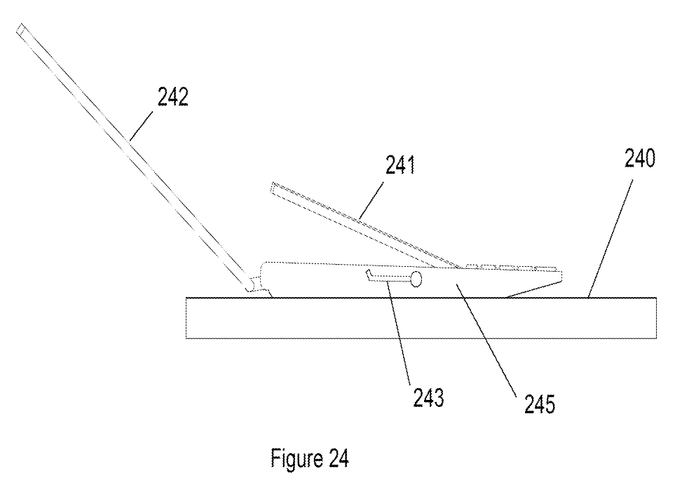

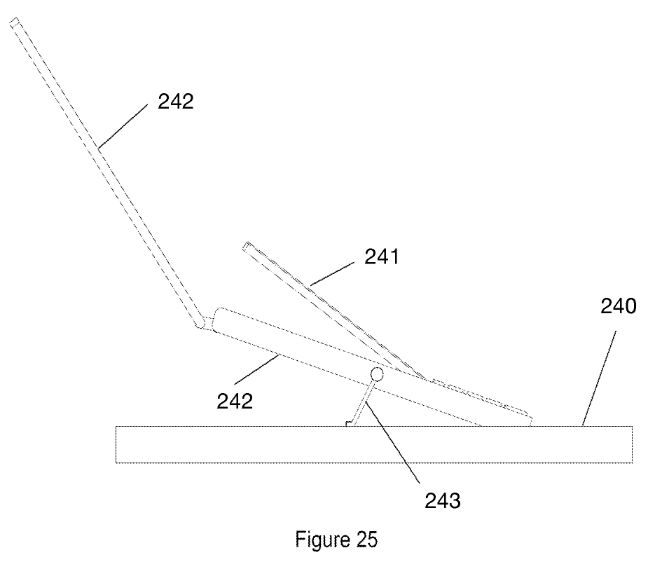

FIG. 24 illustrates an embodiment analogous to that of FIGS. 21-23, but having an alternative incline mechanism. In FIG. 24, the incline mechanism includes a lever 243 rotatably mounted to each of the left and right sides of the laptop base unit 245. In FIG. 24, the lever is shown in non-deployed position. FIG. 25 shows the lever 243 of the incline mechanism in deployed position, lifting the laptop base 242 to a desired viewing angle.

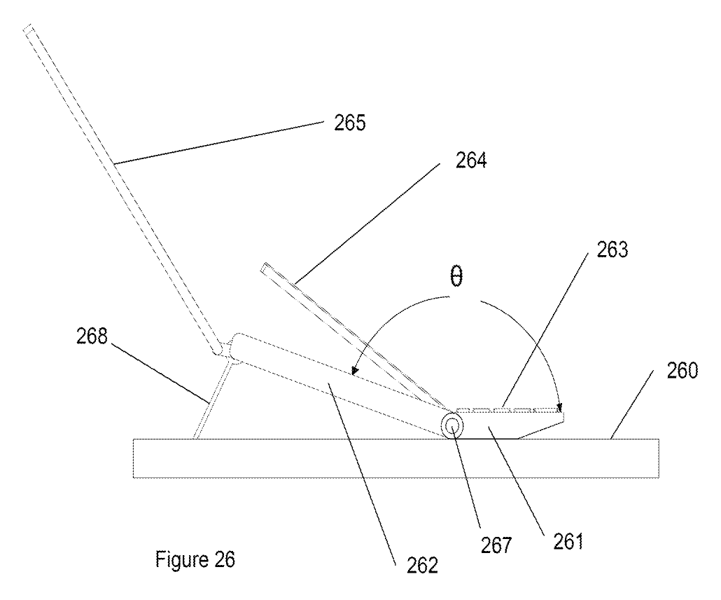

FIG. 26 shows another embodiment wherein the laptop base actually consists of two portions: a frontal portion 261 and a rear portion 262, articulated with respect to each other at pivot 267. Front portion 261 includes keyboard 263. Rear portion 262 includes secondary display screen 264. This embodiment provides one additional degree of freedom: the angle θ between the two base portions. This embodiment provides potentially a better (i.e. flat) positioning of the keyboard surface if the user so desires, while maintaining the ability to adjust the main screen 265, the secondary screen 264 and the incline mechanism 268.

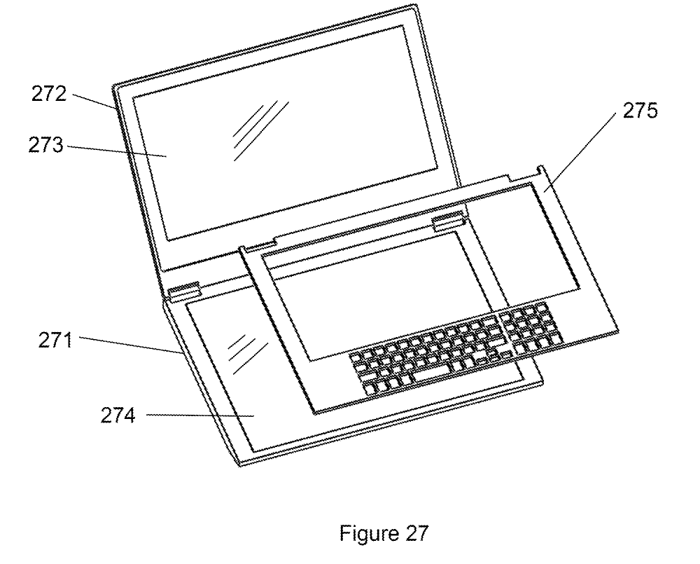

FIG. 27 shows another embodiment, including a main display unit 272 with a main screen 273, and a laptop base 271 with a second screen 274. The incline mechanism mounted on the underside of base 271 is present in this embodiment but it is not seen in the view shown in FIG. 27. The second screen 274 in this embodiment is very large, occupying almost all the area of the laptop base 271. A top panel 275 is shown in exploded view at a distance from the laptop base 271. This top panel is to be mounted on top of the laptop base 271.

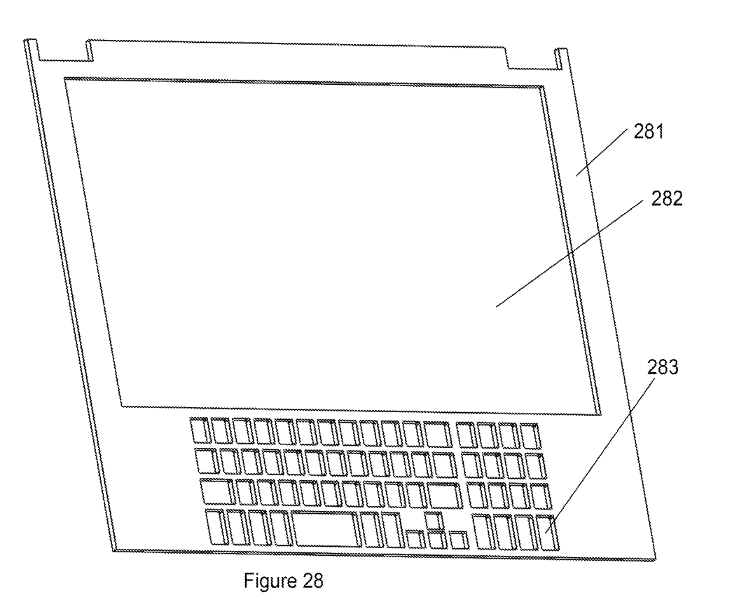

An expanded view of the top panel is shown in FIG. 28. This panel 281 has a large opening 282 for the secondary screen and a plurality of appropriate through-holes 283 for the key images that will be displayed on the secondary screen as part of a virtual keyboard.

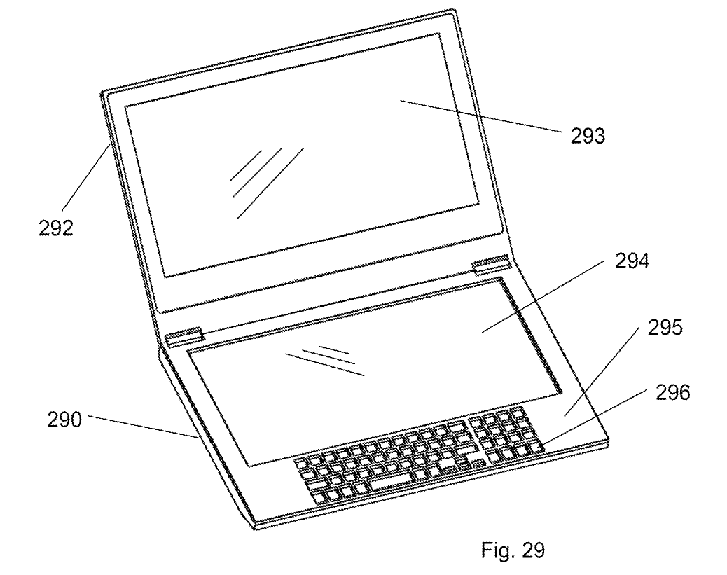

FIG. 29 shows an embodiment analogous to that of FIGS. 27 and 28 after a top panel 295 has been mounted on top of a laptop base 290. The second screen 294 is reachable and touchable through the large opening of the top panel 295. The second screen 294 has a portion of it that is located under the key holes 296 of the top panel. That portion of the second screen 294 is used to display a virtual keyboard with images of the corresponding desired key labels under the key holes 296 of the top panel (similar to the virtual keyboard of an iPhone or an Android phone). Therefore, the user can touch those virtual key through the physical holes 296 in the top panel 295. One advantage of this arrangement is that there is a physical, not touch-sensitive separation between the virtual keys, which helps prevent the false touches and frequent errors of virtual keyboards. Therefore this invention can provide a reliable, not error-prone virtual keyboard with the standard key sizes, standard pitches and distances and standard arrangements that users are used to, which enables quick and reliable typing with high productivity. This virtual keyboard is also illuminated, can be adjusted through software settings for different languages and special symbols, and can even be dynamically adjusted by different applications to assign special meaning or special functions to different keys as needed by the application, providing unprecedented input flexibility and productivity to a laptop computer. This capability of course depends on the ability of the user to see the labels being displayed on the secondary screen through the holes in the top panel, and that is of course enabled by the incline mechanism of the laptop base (present but not seen in FIG. 29).

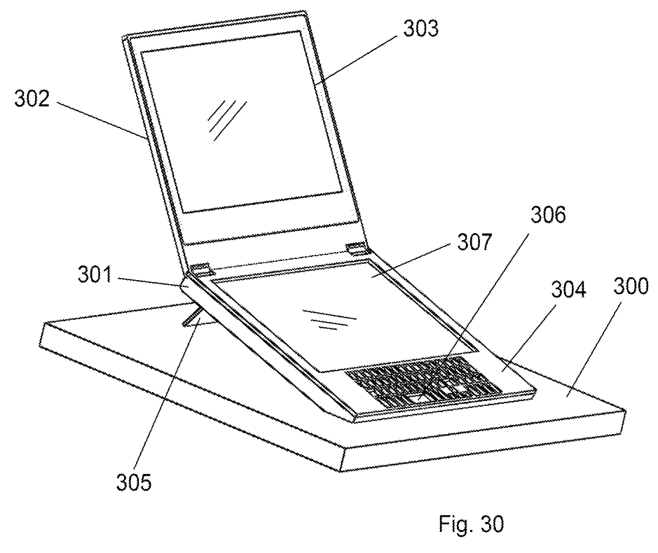

FIG. 30 is a more detailed, perspective view of the same previous embodiment. The laptop is sitting on a desktop or lap surface 300, and it consists of display unit 302 with main screen 303, and laptop base 301 with secondary touch-sensitive screen 307, top panel 304 and incline mechanism 305. The secondary screen 307 extends under the top panel so that the user can touch the virtual keyboard displayed on the screen 307 through the holes 306 of the top panel.

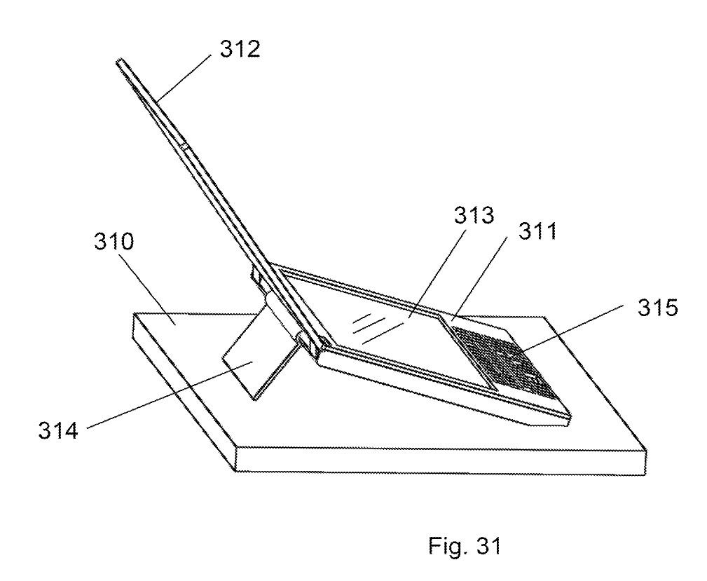

FIG. 31 shows a rear view of an embodiment analogous to that shown in FIG. 30, with secondary screen 313, perforated top panel 311, key holes 315 and incline mechanism 314.

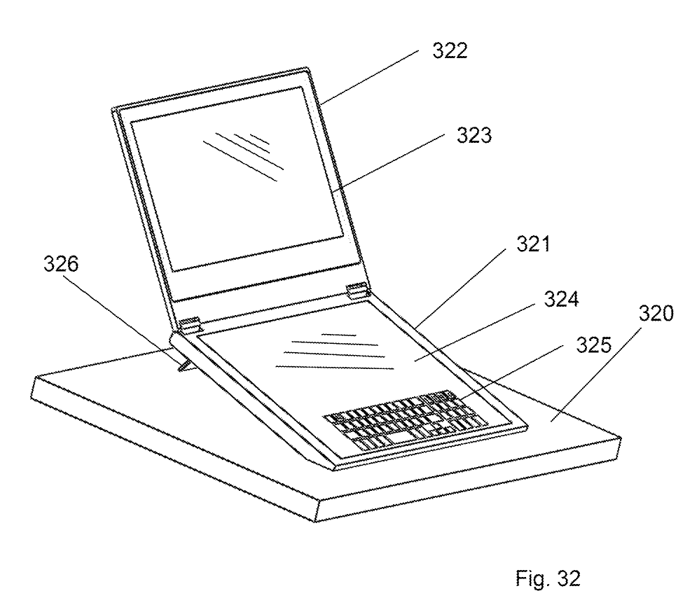

FIG. 32 shows another embodiment. In this embodiment, the laptop sits on desktop or lap surface 320, and it consists of display unit 322 with main screen 323, and laptop base 321 with incline mechanism 326, large secondary screen 324 and virtual keyboard 325 displayed on the secondary screen 324. This embodiment has the disadvantage that it may be more error-prone to some users because of the absence of the top panel of the previous embodiment which helps prevent false touches. It has the advantage though for some users that it provides maximum flexibility in displaying and shaping the keyboard and it even makes it possible to turn off the keyboard when not needed, using the complete surface of the secondary screen 324 for other purposes as needed by different applications. They keyboard can be displayed only when needed by the user.

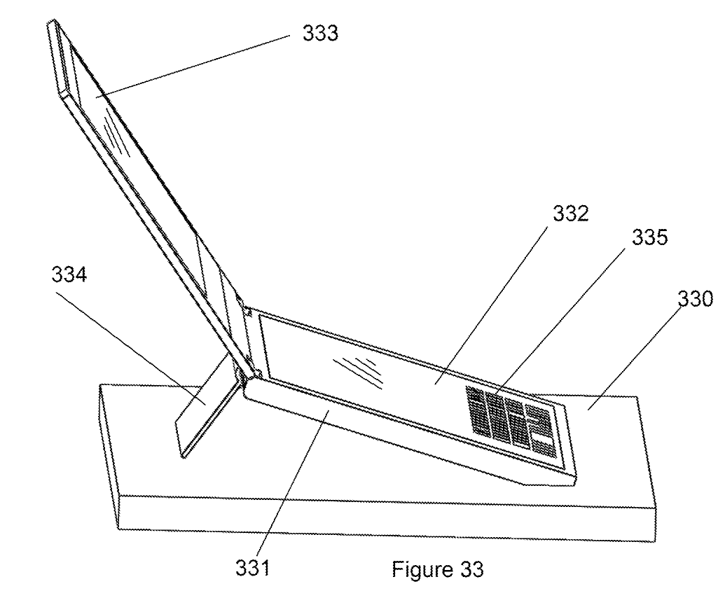

FIG. 33 is a side and rear view of an embodiment analogous to that of FIG. 32, with main screen 333, secondary screen 332, virtual keyboard 335 and incline mechanism 334.

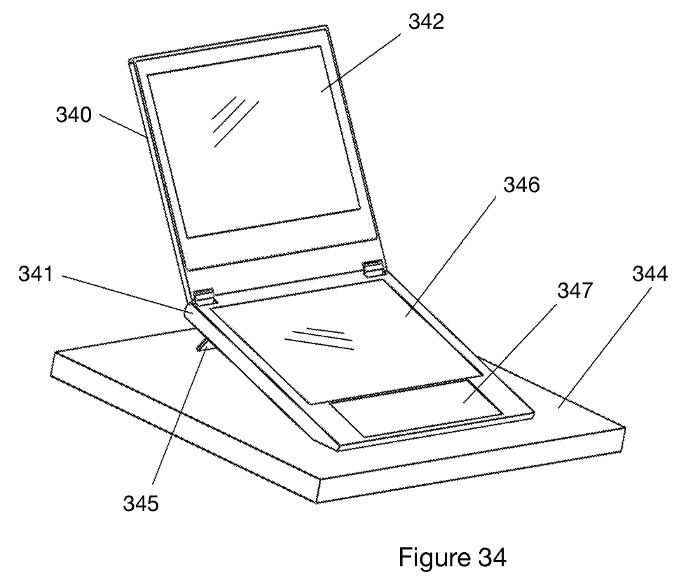

FIG. 34 shows another embodiment, with a base 341, a main screen 342, a secondary display screen 346 and a keyboard touchscreen 347. The screen 347 is intended to display a virtual keyboard. The incline mechanism 345 supports base 341 on desk surface 344, providing a favorable viewing angle.

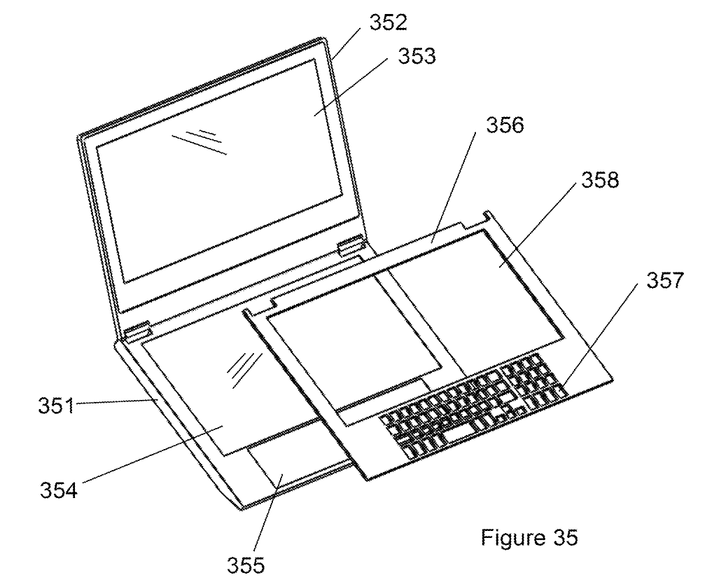

FIG. 35 shows a variation of the previous embodiment, wherein a top panel 356 is mounted on top of the laptop base 351, with a large opening 358 for the secondary display touchscreen 354, and a plurality of through holes 357 to allow the user to touch the virtual keyboard displayed on touchscreen 355.

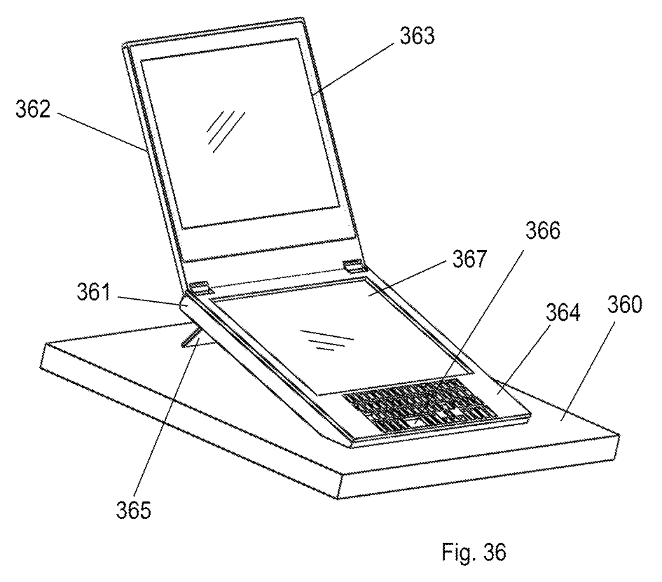

FIG. 36 shows the previous embodiment with the perforated top panel mounted on top of the laptop base 361, and the incline mechanism 365 providing the necessary favorable viewing angle.

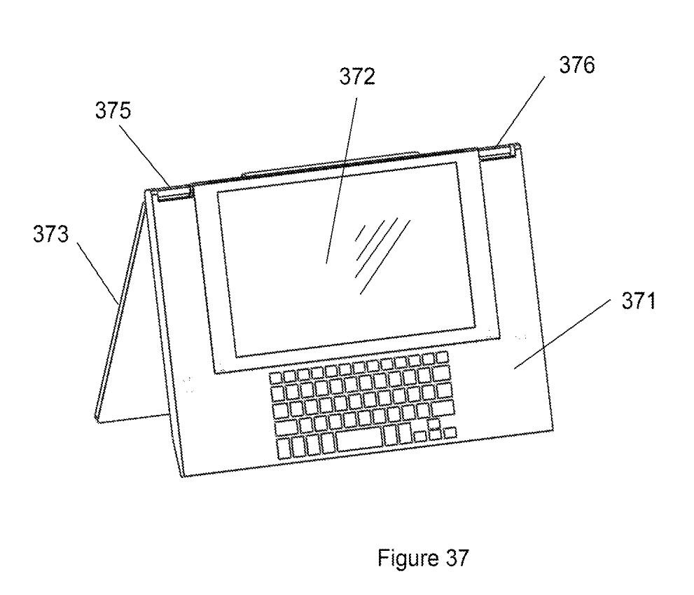

FIG. 37 shows that the previous embodiments can be preferably equipped with extended range hinges 375 and 376, so that they can rotate to angles substantially higher than 180 degrees, whereby the base unit and display unit form an obtuse angle. Such an orientation may, e.g., facilitate presentations, with the user on one side of the laptop using second screen 372 on base unit 371, and the audience on the opposite side, facing a display unit with main screen 373 which displays the presentation.

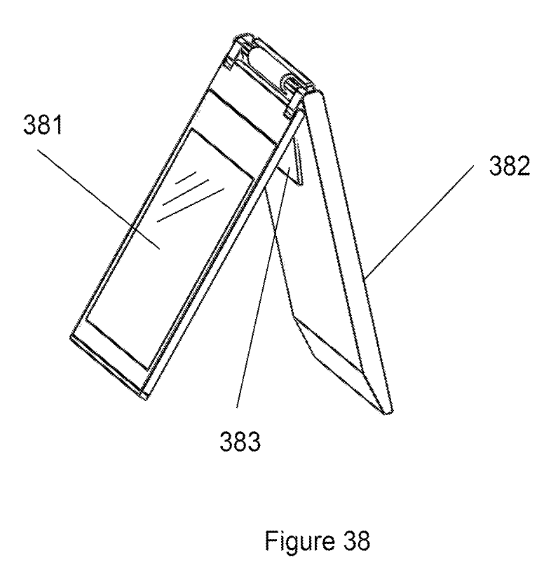

FIG. 38 shows the same previous embodiment viewed from the opposite side, with main screen 381, base 382 and incline mechanism 383 shown in non-deployed position.

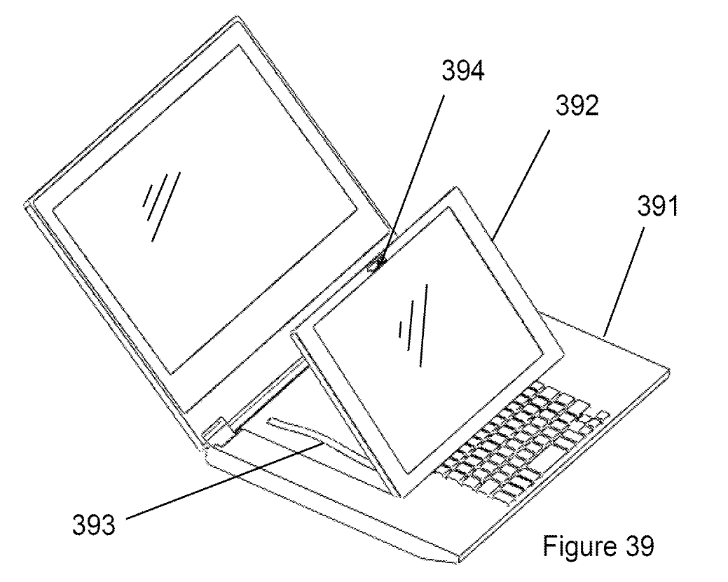

FIG. 39 shows a deployment mechanism for the second screen, based on a latch or hook 394 that normally keeps a set of springs 393 (typically leaf springs for space reasons) under compression under the frame of the second screen 392. Springs 393 bias the second screen towards a deployed position. When the user releases the latch, the springs 393 expand, pushing the second screen 392 up and causing it to automatically rise up to a relatively small angle. Then the user can easily grab the edges of the partially deployed second screen and lift it further to the desired position. The second screen may be pressed back towards the latch to reload springs 393, and engage latch 394 to secure the second display in a stowed position. Many other mechanisms can be used to deploy screen 392 in this embodiment, such as helical springs, cams, gears, threaded pins, etc.

The previously-described embodiments can be implemented using a computer with a Central Processing Unit (CPU) able to support multiple displays, such as the main display unit, the second display unit and potentially additional displays such as a desktop monitor or a projector for presentations. That capability may be achieved by using USB type C connectivity. That makes it possible to provide a portable computer that supports its main display unit, its second internal integrated display unit and additional external optional display units such as monitor(s), projector(s), gaming machines or gaming displays, etc. The portable computer therefore can provide support for some or all of those displays through a USB type C connector. For older legacy devices that don't support USB type C (such as older monitors), a portable computer embodiment can be equipped with additional connectors such as HDMI, VGA, DVI and others, which can be internally connected to the motherboard's USB type C port. Therefore, some embodiments can be initially manufactured with several externally accessible connectors: an external USB type C connector, HDMI, VGA, DVI and others. As legacy connectors become less important, embodiments could provide only an external USB type C connector (thus dropping the other external connectors) and letting users that may still have old legacy devices connect them through an external USB type C hub. The advanced USB type C capabilities of this invention can be achieved by using an advanced CPU such as Skylake or Kaby Lake from Intel.

In some embodiments, the second display unit provided in the base unit of some embodiments can be made detachable from the base unit. Such a detachable second display unit can then be used for alternative purposes, such as an enhanced display for a smart phone, for another computer or for a game machine.

In some embodiments, the second display unit can be made addressable (whether detachable or not) by an external device such as a smartphone, another computer, a gaming machine or another electronic device, to provide an enhanced display for those devices. External device display addressability can be provided through a display data interface implemented by the portable computer, for receiving display data from an external computing device for rendering on the second display panel. A display data interface may be integrated within the second display unit (particularly for embodiments having a detachable second display unit) or elsewhere within the portable computer. In either case, the display interface may provide access to a portable computer display via a wired mode (e.g. through USB type C or other connectors), wirelessly, or both. For example, in some embodiments, a user could be working on a portable computer using the main or primary display unit; meanwhile, a smartphone may be interconnected with the portable computer's second display unit such that the smartphone may output video content to the portable computer display interface for rendering on the second display unit. In such use, calls, smartphone notifications and other smartphone display interactions may be automatically routed to the second display unit, enabling seamless and highly efficient use of multiple devices by the user.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

What is claimed:

1. A portable computer comprising:
a display unit and a base unit attached along a first edge via a first display unit hinge structure in a clamshell configuration, whereby a front surface of the base unit and a front surface of the display unit can fold adjacent to one another;
a first display panel mounted within the display unit, the first display panel comprising the majority of the front surface area of the display unit;
wherein the base unit comprises a top surface having a keyboard within a front portion of the top surface and a second display panel within a rear portion of the top surface, the second display panel comprising a minority of surface area of the base unit top surface; and
an angle adjustment mechanism operable to modify the viewing angle of the second display panel relative to a user of the portable computer.

2. The portable computer of claim 1, in which the angle adjustment mechanism comprises a hinge connecting a front edge of the second display panel to the base unit, whereby a rear edge of the second display panel may be adjusted in height relative to the base unit top surface.

3. The portable computer of claim 1, in which the angle adjustment mechanism comprises a deployable support mounted proximate and extendable below a bottom surface of the base unit, the deployable support movable between a stowed position and a deployed position, the deployable support elevating a rear portion of the base unit above a surface on which the base unit rests when in a deployed position.

4. The portable computer of claim 3, in which the deployable support (a) comprises a flat frame or tab or panel, and (b) is connected to a bottom rear portion of the base unit via a hinge.

5. The portable computer of claim 3, in which the deployable support comprises a left support pivotally mounted to a left side of the base unit, and a right support pivotally mounted to a right side of the base unit.

6. The portable computer of claim 2, further comprising a second angle adjustment mechanism, the second angle adjustment mechanism comprising a deployable support mounted proximate and extendable below a bottom surface of the base unit, the deployable support movable between a stowed position and a deployed position, the deployable support elevating a rear portion of the base unit above a surface on which the base unit rests when in a deployed position.

7. The portable computer of claim 3, in which the second display unit is fixed in position relative to the base unit top surface.

8. The portable computer of claim 3, in which the deployable support is movable between a plurality of static positions.

9. The portable computer of claim 8, in which the plurality of static positions comprise a first position in which the deployable support lies flush with the bottom surface of the base unit, and a second position in which the deployable support extends below the bottom surface of the base unit to elevate a portion of the base unit above a support surface by a predetermined amount.

10. The portable computer of claim 3, in which the deployable support is movable by a user within a range of static positions.

11. The portable computer of claim 1, in which the second display panel is adjustable between a first orientation in which the second display panel is flush with the base unit top surface, and a second orientation in which the second display panel is supported at a predetermined angle relative to the base unit.

12. The portable computer of claim 1, wherein the second display panel is adjustable within a predetermined range of angles relative to the base unit.

13. The portable computer of claim 1, in which the first display unit hinge structure comprises a wide range hinge enabling movement of the display unit relative to the base unit over a range of significantly greater than 180 degrees.

14. The portable computer of claim 1, in which the second display panel (a) is fixed in position relative to the base unit; and (b) comprises a display panel with extended range viewing angle.

15. The portable computer of claim 2, in which the angle adjustment mechanism further comprises: a spring mechanism biased against the second display panel to move the second display panel toward a deployed position in response to release of a latch mechanism.

16. A portable computer comprising:
a display unit comprising a first display panel exposed on a front surface thereof;
a base unit comprising a second display panel exposed on a top surface thereof;
the display unit and base unit attached along a first edge by a wide range hinge structure, whereby the display unit and base unit can be oriented relative to one another (a) in a closed position wherein a front surface of the base unit and a front surface of the display unit fold adjacent to one another, (b) in an open position in which the display unit and base unit form an acute angle, such that the first display panel and the second display panel are oriented towards a common viewer; and (c) a display position in which the display unit and base unit form an obtuse angle, such that the first display panel and the second display panel are oriented in opposing directions.

17. The portable computer of claim 16, in which: the base unit top surface further comprises a keyboard on a front portion thereof; and the second display panel comprises a minority of surface area of the base unit top surface.

18. A portable computer comprising:
a display unit and a base unit attached along a first edge via a first display unit hinge structure in a clamshell configuration, whereby a front surface of the base unit and a front surface of the display unit can fold adjacent to one another;
a first display panel mounted within the display unit, the first display panel comprising the majority of the front surface area of the display unit;
wherein the base unit comprises a top surface having a keyboard within a front portion of the top surface and a second display panel within a rear portion of the top surface;
an angle adjustment mechanism operable to modify the viewing angle of the second display panel relative to a user of the portable computer; and
a first display position adjustment mechanism within the display unit, the first display position adjustment mechanism operable to modify a distance between the first display panel and the base unit;
whereby the first display panel may be elevated to avoid obstruction by the second display panel.

19. The portable computer of claim 18, in which the angle adjustment mechanism comprises a hinge connecting a front edge of the second display panel to the base unit, whereby a rear edge of the second display panel may be adjusted in height relative to the base unit top surface.

20. The portable computer of claim 19, in which the first display position adjustment mechanism comprises one or more rails, along which a user may slide the first display panel.

21. The portable computer of claim 20, in which the first display position adjustment mechanism further comprises a brake to variably fix and release the first display panel for travel along the one or more rails.

22. The portable computer of claim 19, further comprising a second angle adjustment mechanism, the second angle adjustment mechanism comprising a deployable support mounted proximate and extendable below a bottom surface of the base unit, the deployable support movable between a stowed position and a deployed position, the deployable support elevating a rear portion of the base unit above a surface on which the base unit rests when in a deployed position.

23. The portable computer of claim 19, further comprising a second angle adjustment mechanism, the second angle adjustment mechanism comprising one or more deployable supports, each mounted on a side surface of the base unit, the deployable support movable between a stowed position and a deployed position, the deployable support elevating a rear portion of the base unit above a surface on which the base unit rests when in a deployed position.

24. The portable computer of claim 1, further comprising a central processing unit (CPU), the CPU supporting USB type C connectivity to drive the first display panel and the second display panel.

25. The portable computer of claim 18, further comprising a central processing unit (CPU), the CPU supporting USB type C connectivity to drive the first display panel and the second display panel.

26. The portable computer of claim 1, further comprising a display data interface receiving display data from an external computing device for rendering on the second display panel.

27. The portable computer of claim 26, in which the display data interface is integrated within the second display panel; and in which the second display panel is detachable from the base unit.

28. The portable computer of claim 18, further comprising a display data interface receiving display data from an external computing device for rendering on the second display panel.

29. The portable computer of claim 28, in which the display data interface is integrated within the second display panel; and in which the second display panel is detachable from the base unit.
